(19) United States
(12) Patent Application Publication
(10) Pub. No.: US 2012/0072334 A1
(43) Pub. Date: Mar. 22, 2012

(54) RESPONSIBILITY ANALYTICS

(76) Inventors: Jeffrey A. Feinstein, Roswell, GA (US); Wei Jiang, San Leandro, CA (US); Ryan Morrison, San Rafael, CA (US); Shane De Zilwa, Oakland, CA (US)

(21) Appl. No.: 12/939,975

(22) Filed: Nov. 4, 2010

Related U.S. Application Data
(60) Provisional application No. 61/258,141, filed on Nov. 4, 2009.

(51) Int. Cl. G06Q 40/02

(52) U.S. Cl. 705/38

(57) ABSTRACT

A request to generate a responsibility score is received that characterizes a likelihood of a change in a level of creditworthiness of an individual in response to at least one unknown financial event. Such responsibility score can provide useful insight into a consumer that is complementary to a credit score. Thereafter, a responsibility score is generated based on historical creditworthiness data for the individual using at least one predictive model. The at least one predictive model was trained using historical creditworthiness data of a plurality of consumers subjected to a plurality of financial events. In addition, the at least one predictive model associates the historical creditworthiness data of the individual with matching states for each of a plurality of pre-defined performance behaviors—with each pre-defined performance behavior having at least two corresponding states. The responsibility score can be later provided to a user (e.g., persisted, transmitted, displayed, etc.). Related apparatus, systems, techniques, and articles are also described.

### RELATED APPLICATION

The current application claims priority to U.S. patent application Ser. No. 61/258,141 entitled “Responsibility Analytics” filed on Nov. 4, 2009, the contents of which are hereby fully incorporated by reference.

### TECHNICAL FIELD

The subject matter described herein relates to systems, techniques, and article for characterizing financial responsibility using analytics.

### BACKGROUND

Individuals with similar credit profiles may have differing behavioral traits/patterns which can cause them to be more or less attractive as a recipient of credit. For example, certain behavioral traits may be correlated or otherwise related to responsible management of credit while other behavioral traits may suggest irresponsible credit management.

The market is currently dealing with a fundamental issue in predicting consumers who are likely to continue to pay effectively, and those that are going to falter. Conventional systems and techniques cannot identity or otherwise characterize factors interacting with credit risk in order to predict who is likely to take adverse actions (that are often avoidable) relating to their creditworthiness.

### SUMMARY

The current subject matter provides a broad-based tool that can be used to identify the tendency of an individual to act in a responsible manner when faced with unspecified events in the future. These unspecified events can include events such as mortgage rate reset (e.g., expiration of initial term for ARM mortgage, etc.), consolidation of two or more loans, interest rate fluctuations, hardships (e.g., divorce, job loss, job change, etc.). The reactions to such events are not always captured by conventional scores, such as credit scores which are often snapshots of historical events.

The current subject matter is based on well mined data that allow for better models to seek out consumer dispositions that drive their behavior (responsibility, honesty, generosity, integrity, etc.). While the current subject matter is directed to identifying a responsibility dimension which functions to drive a consumer's responses to a myriad of credit stressors, other behavioral traits/characteristics can be identified. More generally, the current subject matter recognizes that there is value in differentiating responsible from irresponsible consumers. A responsible consumer is better prepared against negative stressors, likely to “do the right thing” through the stressful event, and is quicker to recover in light of positive upswing. An irresponsible consumer that is poorly prepared to face negative stress stressors may under-react when attempting to cope with stressors, and more likely to step into credit traps. In particular, the current subject matter maps the structure of responsibility with analytics/techniques surveying the range of potential consumer responsible and irresponsible actions over time.

In one aspect, a request to generate a responsibility score is received that characterizes a likelihood of a change in a level of creditworthiness of an individual in response to at least one unknown financial event. Thereafter, a responsibility score is generated based on historical creditworthiness data for the individual using at least one predictive model. The at least one predictive model was trained using historical creditworthiness data of a plurality of consumers subjected to a plurality of financial events. In addition, the at least one predictive model associates the historical creditworthiness data of the individual with matching states for each of a plurality of pre-defined performance behaviors—with each pre-defined performance behavior having at least two corresponding states. The responsibility score can be later provided to a user (e.g., persisted, transmitted, displayed, etc.).

The predictive model can uses a scorecard model methodology in some implementations or a factor analysis technique in other arrangements. With the scorecard model methodology, predictive models can be generated for each performance behavior each of which generating a partial score that can be aggregated or otherwise combined to generate a responsibility score. With a factor analysis technique, the performance behaviors are reduced into a smaller number of performance dimensions. These performance dimensions can be orthogonal (i.e., each performance dimension can define dimensions containing unique variance with regard to the other performance dimensions, etc.). The at least one unknown financial event can occurs subsequent to a date at which a credit score was established for the individual (and similarly the data used to train the model can take into account the credit scoring date, etc.).

With the current subject matter, individuals with the same credit score or other score, can have different responsibility scores. The historical data for the individual can be masterfile data, credit bureau data, and/or other creditworthiness data.

In another aspect, at least one model for generating responsibility scores is built by: gathering historical creditworthiness related data for a plurality of consumers, deriving a plurality of performance behaviors from the historical creditworthiness data, building a predictive model for each of the performance behaviors using the historical creditworthiness data, and defining a single combined responsibility performance score aggregating and/or combining the results of the predictive model. Thereafter, access to the built at least one model for generating responsibility scores is enabled so that responsibility scores can be calculated for an individual using his or her personal historical creditworthiness data.

In a further aspect, at least one model for generating responsibility scores can be built by: gathering historical creditworthiness related data for a plurality of consumers, deriving a plurality of performance behaviors from the historical creditworthiness data, performing factor analysis to associate the matching states of the pre-defined performance behaviors with matching states of performance dimensions, the number of performance dimensions being fewer than the number of performance behaviors, building a predictive model for each of the performance behaviors using the historical creditworthiness data, and defining a single combined responsibility performance score aggregating and/or combining the results of the predictive model. Thereafter, access to the built at least one model for generating responsibility scores can be enabled so that responsibility scores can be calculated for an individual using his or her personal historical creditworthiness data.

In another aspect, a request is received to generate a suite of responsibility scores, each responsibility score characterizing a likelihood of an adverse change in a level of creditworthiness of an individual on one of several dimensions. Such individual may have an identical credit score to another individual, however, his or her responsibility scores may be different. Future behavioral traits are estimated for the individual using a predictive model trained using historical creditworthiness data and behavioral data of a plurality of individuals. These behavioral traits are associated with responsibility scores which can be displayed/transmitted to the requester.

Articles are also described that comprise a machine-readable medium embodying (e.g., non-transitorily storing, etc.) instructions that when performed by one or more machines result in operations described herein. Similarly, computer systems are also described that may include a processor and a memory coupled to the processor. The memory may encode one or more programs that cause the processor to perform one or more of the operations described herein. For computer-implemented methods, the various operations can be implemented by one or more data processors (forming part of a single computer system or distributed among two or more computing systems).

The subject matter described herein provides many advantages. For example, the current responsibility scores provide further insight into individuals in connection with financial behavior—which in turn can affect creditworthiness. Such responsibility scores can be used to differentiate/segment consumer populations in order to take into account how an individual might behave in the future (which behavior might differ from other individuals with identical or substantially identical historical behavior). Stated in the context of creditworthiness, a consumer's credit management style can be a more direct measure of character than is their credit risk (which can be characterized by a credit score).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a technique for generating a responsibility score;

FIG. 2 is a diagram illustrating sample performance dimensions utilized in connection with the generation of a responsibility score;

FIG. 3 is a diagram illustrating how responsibility scores for a particular performance dimension can provide additional insight into the consumer that is complementary to a bankcard score; and

FIG. 4 is a diagram illustrating variations in consumer bad rates when performance dimension responsibility scores are segmented.

### DETAILED DESCRIPTION

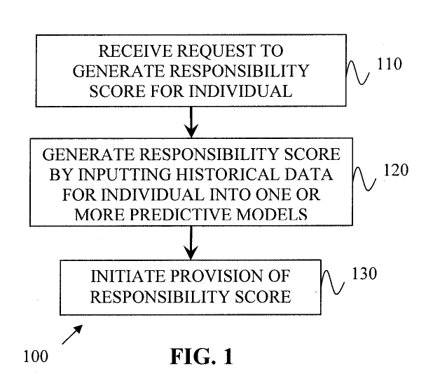

FIG. 1 is a process flow diagram illustrating a method 100 in which, at 110, a request to generate a responsibility score is received that characterizes a likelihood of a change in a level of creditworthiness of an individual in response to at least one unknown financial event. Thereafter, at 120, a responsibility score is generated based on historical creditworthiness data for the individual using at least one predictive model. The at least one predictive model was trained using historical creditworthiness data of a plurality of consumers subjected to a plurality of financial events. In addition, the at least one predictive model associates the historical creditworthiness data of the individual with matching states for each of a plurality of pre-defined performance behaviors—with each pre-defined performance behavior having at least two corresponding states. The responsibility score can be later provided, at 130, to a user (e.g., persisted, transmitted, displayed, etc.).

Initially, at least one dataset that characterizes consumer actions with regard to financial issues can be examined. These datasets may be derived from masterfile, credit bureau, and/or other data sources provided that sufficient specificity is provided to describe activities for a large population of consumers during a predefined time period. From this dataset, performance behaviors (i.e., dimensions, etc.) can be identified—each behavior having consumers characterized as being responsible while other consumers being characterized as irresponsible. In one implementation, fifteen (15) different performance behaviors were identified including: 1) Highly utilized and new card then total balance increases; 2) Consistently pays less than spends; 3) Lazy payers, A. All consumers; B. Revolvers; 4) Seeking Credit during delinquency (new trades, inquires); 5) 2+ over limits in performance period, A. $0 threshold; $50 threshold; 6) Increasing balance through delinquency/charge-off; 7) Self-cure at end of performance period; 8) Walk away mortgage; 9) Balance change following consolidation; 10) Unnecessary fee accrual, A. Number of months with fees; B. Number of returned checks; 11) Revolver indicator in historical data (e.g., credit bureau data), high balance to limit ratio A. No restriction at observation; B. Restrict to low utilization at observation; 12) Total amount of interest/fees paid per month, A. Interest paid per month B. Total $ amount of fees paid per month; 13) number of open mortgages; 14) Ratio of payments to minimum required payments; and 15) Ratio of payments to purchases, continuous.

In one example, the above-referenced fifteen performance behaviors were built on a dataset obtained over three years for hundreds of consumers. For each consumer, responsible/irresponsible acts were measured during a performance period after a credit scoring date (i.e., the date on which a credit score was generated for a particular consumer, etc.). Two methodologies were used to characterize the measured acts. A first methodology used a scorecard method while the second methodology used a factor analysis method.

The first methodology which used the scorecard method was built to predict the ratio between the number of responsible and irresponsible actions within the performance period. In particular, custom designed performance measures were used to tap responsible/irresponsible behavior between a scoring date and the performance data. This performance data utilized both masterfile and credit bureau data to characterize the behavior of each consumer during the performance period. Two separate responsibility scores were generated, the first solely utilizing the masterfile performance data and the second solely utilizing the credit bureau data. Stated differently, the predictive models were trained with predictor data that can be generated from masterfile, credit bureau data and other data sources, and the performance variable can be a weighted combination of responsible/irresponsible rankings/states observed for a time period subsequent to a scoring date. The responsibility scores were generated using scorecard models that were, in turn, based on how the particular consumer fared for each of the fifteen performance behaviors (with the behaviors having various weightings to form the score and/or based on a ratio of responsible/irresponsible rankings overall for the fifteen performance behaviors). It will be appreciated that either masterfile or credit bureau data as well as other data could have been used provided that such data provided sufficient insight into the behavior of the consumer during the performance period.

With the second methodology, factor analysis was used to characterize variability among the observed performance variables in terms of a lower number of unobserved dimensions, referred to herein as factors. In this context, variations in the larger number of observed performance behaviors reflected variations in a reduced number of unobserved factors. The observed performance behaviors were modeled as linear combinations of the potential factors, plus “error” terms. The information gained about the interdependencies between observed variables was used to reduce the set of performance behaviors in the dataset into the performance dimensions (it will be appreciated that the performance behaviors also comprise dimensions and that their reference as “behaviors” is used for differentiation purposes). The five factors included: (1) Clean vs. Delinquent—with the primary driving variables relating to delinquency; (2) Stable Credit vs. Credit Farmer—Seekers (irresponsible consumers seek credit more often and/or in greater amounts), Growing Balances (irresponsible consumers more often having growing balances), File Thickness (irresponsible consumers have greater “files”—meaning that they have more transactions/items within their performance data); (3) On Time vs. Sloppy Payer—Fees and Missed Payments (irresponsible consumers miss payments more often and have resulting fees), Past due amounts (irresponsible consumers have more past due events), Balances (e.g., masterfile balances, credit bureau balances, etc.); (4) High vs. Low Balance—Revenue (IR generate more), Higher and increasing balances (e.g., master filebalances, etc.); and (5) Consolidator vs. Non-Consolidator, Seeking, inquiries and recently opened trades (responsible consumers do more), Thicker files, greater concentration of revolving credit (responsible consumers have more), Lower Utilization, less revenue (responsible consumers have less), Similar Balances. With the factor analysis, indications were provided for each of the five performance dimensions indicating whether each particular user was responsible/irresponsible. It will be appreciated that these individual responsibility scores for the “reduced” performance dimensions can be aggregated or otherwise combined to result in one or more scores.

There are many different predictive methodologies that can be utilized to generates a responsibility score that connects what is known about a particular consumer and subsequently observed responsible/irresponsible behavior for such consumer. Future Action Impact Modeling (FAIM) (see, for example, U.S. patent application Ser. No. 11/832,610, filed on Aug. 1, 2007, the contents of which are hereby fully incorporated by reference) can be used so that future implications of unknown future events that affect creditworthiness can be predicted. For example, once the performance behaviors have been identified, a predictive model can be used to generate a responsibility score (either overall or for individual performance behaviors and/or performance dimensions). Such a predictive model can be a scorecard model developed using FAIM or the ModelBuilder™ software suite of Fair Isaac Corporation and can be trained using the dataset characterizing financial activities of the population of consumers during a performance time period. In some implementations, a divergence-based optimization algorithm can be trained using the data obtained from the dataset based on performance data from a large population of consumers during a performance period (which may be subsequent to a credit scoring date at which a credit score was obtained for the particular consumer). The underlying predictive model may use a variety of predictive technologies, including, for example, neural networks, support vector machines, and the like in order to predict future creditworthiness of a single user based on historical data from a large number of users.

The consumers once they have been scored (using either the scorecard model or the factor analysis technique) can be segmented into different groups. These groups can be used to characterize sub-populations, and in some cases, to provide specialized offerings or give specialized treatment. For example, offers can be targeted to sensitivities of each segment. Balance transfer offers can be offered to “consolidators”, penalty pricing can be applied to “sloppy payers”, early collections can be initiated for “delinquents”, and credit limit increases and/or promotional APRs can be provided to “credit farmers”.

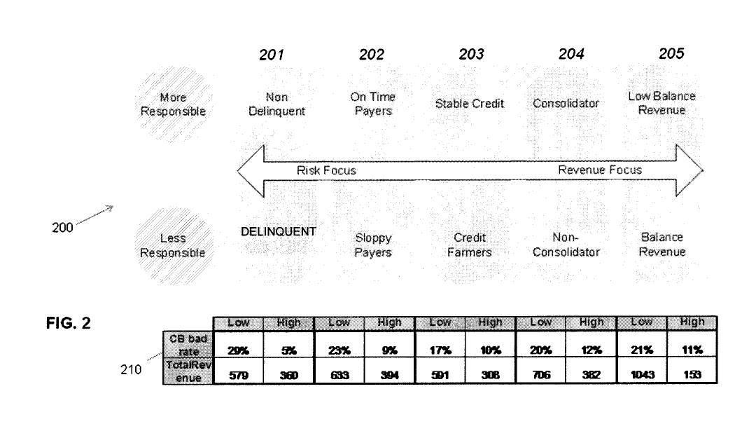

FIG. 2 is a diagram 200 illustrating five sample performance dimensions 201-205 (non-delinquent/delinquent, on time payers/sloppy payers, stable credit/credit farmers, low balance revenue/balance revenue, each having two states (e.g., more responsible, less responsible) identified using factor analysis techniques. This diagram 200 illustrates the value of identifying such performance dimensions 201-205 especially with regard to the tradeoff with regard to risk vs. revenue. In addition, a table 210 is provided which indicates, for each performance dimension 201-205, how each state (low corresponding to less responsible and high corresponding more responsible) relates to a credit bureau bad rate (e.g., default rate, etc.) and potential revenue (in relative terms). Such rich information can be used to make informed risk decisions with regard to individuals as well as over portfolio compositions.

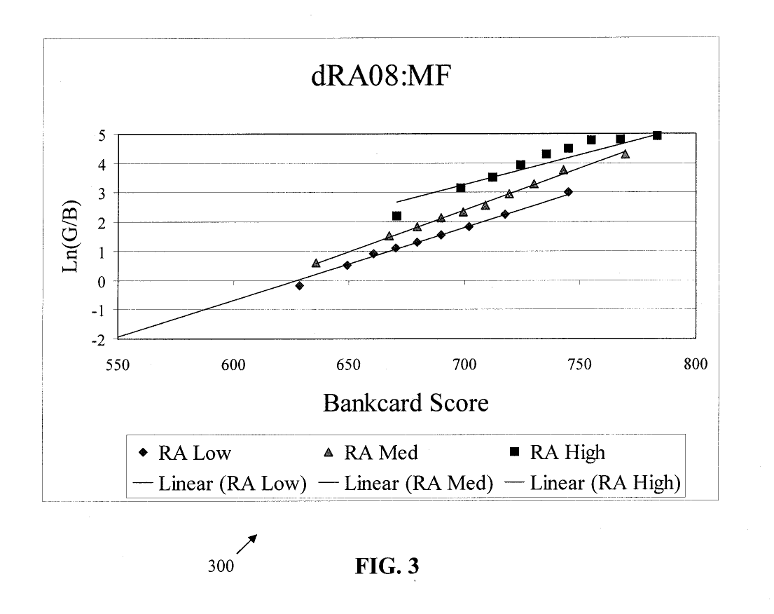

FIG. 3 is a diagram 300 illustrating how a specific individual performance dimension responsibility score (i.e., a responsibility score for a single performance dimension as opposed to an aggregation or combination of same) can add value to existing risk scores (in this case a bankcard score). In diagram 300, the x-axis is risk score (behavior score) which measures the probability of being good and making payments on time. The y-axis is log odds. FIG. 3 shows that even within the same risk score band, which is supposed to have the same risk level, the responsibility score for a particular performance dimension can be used to separate a population of consumers.

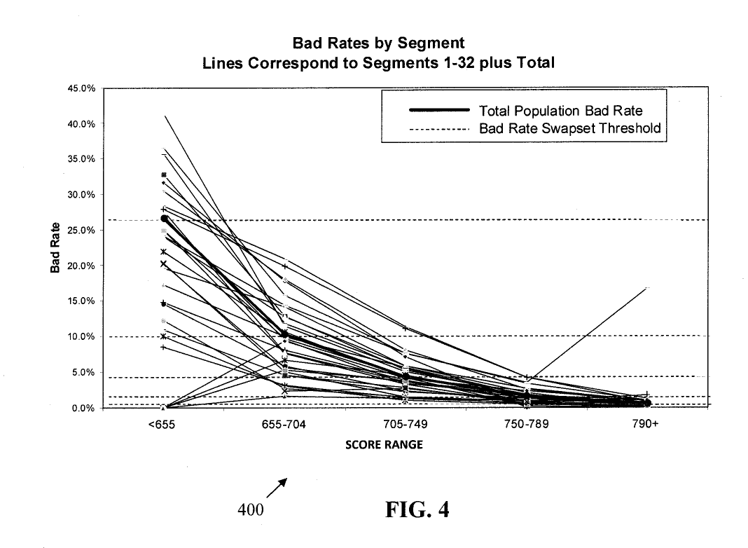

FIG. 4 is a diagram 400 illustrates the value of the performance dimensions if they are further segmented. For example, if the five performance dimension responsibility score are taken and each has a cut-off to define high and low, then we could end up with 32 segments (based on the number of overall combinations). FIG. 4 demonstrates that variations that can occur within the same score band with regard to “bad rate” percentages.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, it will be appreciated that the subject matter described herein can utilize additional or substitute data sets that represent credit behavior and/or performance. Such datasets include, and are not limited to, credit bureau data, masterfile, application data, and demographic data. Other embodiments may be within the scope of the following claims.

What is claimed is:

1. An article comprising a non-transitory machine-readable medium embodying instructions that when performed by one or more machines result in operations comprising:
receiving a request to generate a responsibility score, the responsibility score characterizing a likelihood of a change in a level of creditworthiness of an individual in response to at least one unknown financial event;
generating a responsibility score based on historical creditworthiness data for the individual using at least one predictive model, the at least one predictive model being trained using historical creditworthiness data of a plurality of consumers subjected to a plurality of financial events, the at least one predictive model associating the historical creditworthiness data of the individual with matching states for each of a plurality of pre-defined performance behaviors, each pre-defined performance behavior having at least two corresponding states; and
initiating provision of the responsibility score.

2. An article as in claim 1, wherein one or more of the at least one predictive model uses a scorecard model methodology.

3. An article as in claim 1, wherein the generating comprises:
performing factor analysis to associate the matching states of the pre-defined performance behaviors with matching states of performance dimensions, the number of performance dimensions being fewer than the number of performance behaviors.

4. An article as in claim 4, wherein the performance dimensions are orthogonal.

5. An article as in claim 4, wherein each performance dimension defines dimensions containing unique variance with regard to the other performance dimensions.

6. An article as in claim 1, wherein the at least one unknown financial event occurs subsequent to a date at which a credit score was established for the individual.

7. An article as in claim 6, wherein there are a plurality of individuals having a same value for a corresponding credit score, and wherein the responsibility scores among the plurality of individuals vary.

8. An article as in claim 1, wherein the historical data associated with the individual is derived from masterfile data.

9. An article as in claim 8, wherein the historical data associated with the individual is further derived from credit bureau data.

10. An article as in claim 1, wherein the historical data associated with the individual is derived from credit bureau data.

11. An article as in claim 1, wherein the responsibility score is provided by displaying the responsibility score.

12. An article as in claim 1, wherein the responsibility score is provided by transmitting the responsibility score over a communications network to a remote user.

13. An article comprising a non-transitory machine-readable medium embodying instructions that when performed by one or more machines result in operations comprising:
building at least one model for generating responsibility scores by:
gathering historical creditworthiness related data for a plurality of consumers;
deriving a plurality of performance behaviors from the historical creditworthiness data;
building a predictive model for each of the performance behaviors using the historical creditworthiness data;
defining a single combined responsibility performance score aggregating and/or combining the results of the predictive model; and
enabling access to the built at least one model for generating responsibility scores so that responsibility scores can be calculated for an individual using his or her personal historical creditworthiness data.

14. An article comprising a non-transitory machine-readable medium embodying instructions that when performed by one or more machines result in operations comprising:
building at least one model for generating responsibility scores by:
gathering historical creditworthiness related data for a plurality of consumers;
deriving a plurality of performance behaviors from the historical creditworthiness data;
performing factor analysis to associate the matching states of the pre-defined performance behaviors with matching states of performance dimensions, the number of performance dimensions being fewer than the number of performance behaviors;
building a predictive model for each of the performance behaviors using the historical creditworthiness data;
defining a single combined responsibility performance score aggregating and/or combining the results of the predictive model; and
enabling access to the built at least one model for generating responsibility scores so that responsibility scores can be calculated for an individual using his or her personal historical creditworthiness data.

15. An article comprising a non-transitory machine-readable medium embodying instructions that when performed by one or more machines result in operations comprising:
receiving, for each of a large population of individuals, a request to generate a responsibility score, the responsibility score characterizing a likelihood of a change in a level of creditworthiness of an individual in response to at least one unknown financial event;
generating, for each individual, a responsibility score based on historical creditworthiness data for the individual using at least one predictive model, the at least one predictive model being trained using historical creditworthiness data of a plurality of consumers subjected to a plurality of financial events, the at least one predictive model associating the historical creditworthiness data of the individual with matching states for each of a plurality of pre-defined performance behaviors, each pre-defined performance behavior having at least two corresponding states; and
segmenting each of the individuals into a plurality of groups based on the corresponding performance behavior state combinations for each individual.

16. An article as in claim 15, wherein the generating comprises:
performing, for each individual, factor analysis to associate the matching states of the pre-defined performance behaviors with matching states of performance dimensions, the number of performance dimensions being fewer than the number of performance behaviors; and
wherein the segmenting is further based on the combination of performance dimensions for each individual.

17. An article as in claim 16, wherein the performance dimensions are orthogonal.

18. An article as in claim 16, wherein each performance dimension defines dimensions containing unique variance with regard to the other performance dimensions.
